(19) United States
(12) Patent Application Publication
(10) Pub. No.: US 2006/0179123 A1
(43) Pub. Date: Aug. 10, 2006

(54) Techniques for providing faster access to frequently updated information

(75) Inventor: Pamela Smith, Lawrenceville, NJ (US)

Correspondence Address: MORGAN LEWIS & BOCKIUS LLP, 1111 PENNSYLVANIA AVENUE NW, WASHINGTON, DC, 20004, US

(73) Assignee: Merrill Lynch & Co. Inc

(21) Appl. No.: 10/699,545

(22) Filed: Jul. 16, 2004

Related U.S. Application Data
(63) Continuation of application No. 09/523,342, filed on Mar. 10, 2000, now abandoned.
Application No. 09/523,342 is a continuation-in-part of application No. 08/900,764, filed on Jul. 25, 1997, now abandoned.

(51) Int. Cl. G06F 15/16

(52) U.S. Cl. 709/218

(57) ABSTRACT

Faster access to frequently updated data is provided by using a web farm to automatically download such information from a remote server. The web farm then stores this information on a cache accessible from any of a plurality of browser-equipped workstations. The browser-equipped workstations are connected by a communications network to the web farm which comprises one or more local servers and associated data storage devices.

### FIELD OF THE INVENTION

The invention relates generally to systems and methods for retrieving data from remote servers, and more specifically, to systems and methods for automatically retrieving and caching frequently-updated remote data for subsequent retrieval by local users.

### BACKGROUND OF THE INVENTION

The current explosion in Internet usage is well known. The increased amount of information available from the Internet has increased the average user's data retrieval load so significantly as to stretch the bounds of available equipment. As a result, problems with available bandwidth, server load, and overall network traffic may occur. Individuals “surfing” the web are well-acquainted with these limitations, even when using relatively high bandwidth connections. One partial solution to these problems has been the use of a cache provided by a user's workstation. The first time that a particular web page is downloaded to the workstation, the web page is stored on this cache, typically by using the workstation's hard drive. The next time that page is accessed by the workstation, the workstation and/or the remote server can often determine that the page has not been changed, and or only the portions of data from local storage, rather than adding load to the network lines.

For example, Microsoft's Internet Explorer and Netscape's Navigator programs both include local caching of accessed web pages. Although these caches are widely used and accepted, they have limited application. As a general matter, each of these caches uses a local data storage drive accessible from a specific workstation. Each workstation can be equipped with such a cache, but the cache of one workstation is generally not accessible from another workstation. Accordingly, even if a web page has been previously-accessed by other workstations on a local area network, a workstation that has not accessed this page before is not able to retrieve this page from the caches of other workstations. Network bandwidth is effectively wasted in operational environments where each of the workstations is likely to access the same web page or pages repeatedly, on an ongoing basis.

In a corporate or other group environment, it is often the case that many users, sharing similar interests, will access the same material from the web on a frequent basis, but via any of a plurality of different workstations. For instance, investment firms may wish to track the ever-changing stock market by using a group of employees and/or consultants, where each employee and/or consultant is furnished with a workstation. These workstations are typically coupled to one or more local servers, so as to provide the workstations with Internet access. Overall, this creates a heavy data transfer load between the local server(s) and a remote data server. The same web page is repeatedly transferred, but to a different workstation each time. Moreover, while individual client workstations may each have local caches, the connection to the remote server is still required, at the very least to determine if a page has changed since the last time that the page was accessed by a particular workstation. To date, the main solution to this throughput problem has been to add more bandwidth and more equipment, often at significant expense compared to the resulting performance gain.

### SUMMARY OF INVENTION

In view of the deficiencies of the prior art, it is an object of the invention to provide faster access to frequently-updated information on a remote server.

It is another object of the invention to provide automatic caching of remote data for use by any of a plurality of local workstations.

It is a still further object of the invention to decrease the overall bandwidth needed to access remote data.

It is yet another object of the invention to provide faster access to information which may include embedded content and/or altered data paths at the remote server.

It is yet a further object of the invention to provide an automatic caching system that is easy and cost-effective to implement and operate.

In accordance with the objects of the invention, faster access to frequently-updated information is provided by using a web farm to automatically download such information from a remote server and store this information on a cache accessible from any of a plurality of browser-equipped workstations. The plurality of browser-equipped workstations are connected by a communications network to the web farm which comprises one or more local servers and associated data storage devices. The one or more local servers are adapted for coupling to a wide-area and/or global network having numerous remote servers. Data from selected remote servers and/or websites may be retrieved in any of two ways. First, data may be automatically retrieved by the web farm and stored on a repeated and/or periodic and/or prescheduled basis. Second, data may be retrieved in response to a request for that data at any of the workstations. Moreover, the web farm may optionally be equipped with a tracking mechanism to identify one or more websites and/or remote servers which are accessed on a relatively frequent basis by any of the workstations. These relatively frequently-accessed websites and/or remote servers are then selected for the automatic data retrieval process described above. The retrieval of data in this manner ensures that the data will be relatively up to date. When a workstation attempts to access data (for example, a given web page) that has already been retrieved from one of the remote servers and stored at the web farm, the web farm intercepts the request and retrieves the data from the appropriate cache as stored on a locally-accessible data storage device cache instead.

### BRIEF DESCRIPTION OF THE DRAWINGS

The foregoing and other objects and advantages of the present invention will become apparent to those skilled in the art upon reading the following detailed description of the preferred embodiments in conjunction with a review of the appended drawings, in which:

FIG. 1 is hardware block diagram of an illustrative computer network on which the techniques of the present invention may be performed.

FIG. 2 is a flowchart setting forth an illustrative procedure for automatic caching according to the techniques of present invention;

FIG. 3 is a flowchart showing data retrieval techniques according to an illustrative embodiment of the present invention; and

FIG. 4 is a screen display of an input box for customizing the system according to an embodiment of the present invention.

### DETAILED DESCRIPTION OF THE PREFERRED EMBODIMENTS

In overview, the system provides fast access to frequently updated information by automatically caching data received from remote servers. The data may be stored in any of a number of cache locations and is retrieved from remote servers according to the novel methods described more fully below.

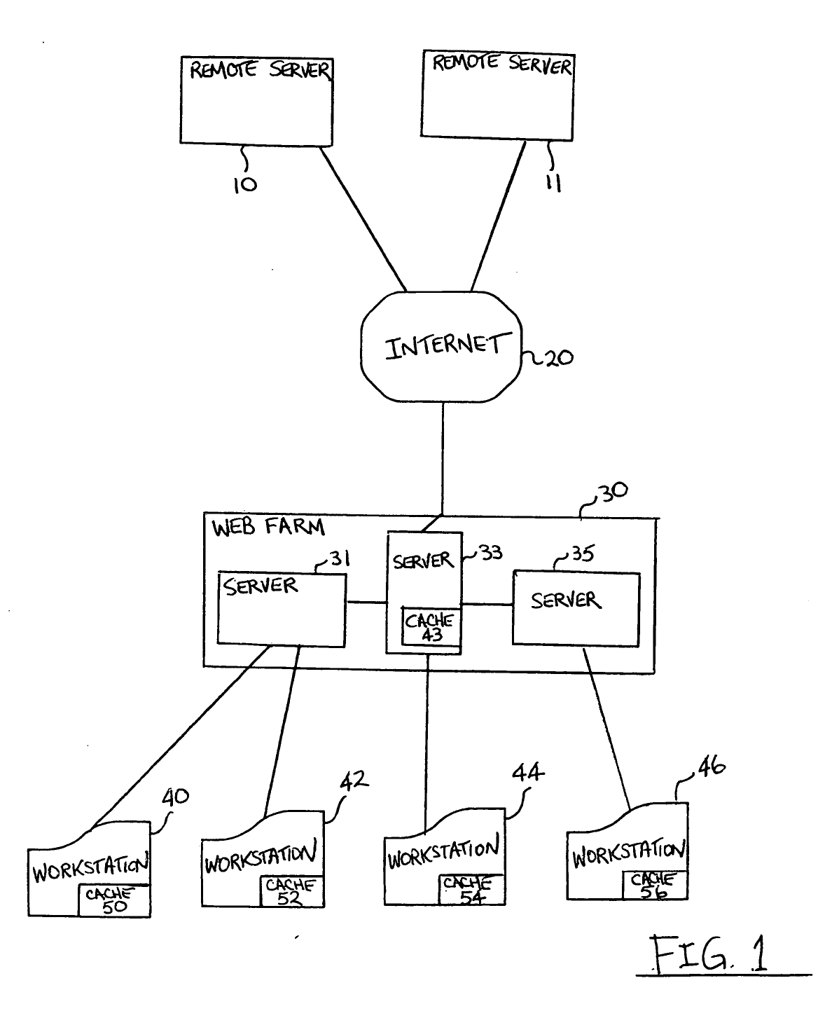

Referring now to FIG. 1, an overall hardware block diagram of a computer network embodying the present invention is shown. As will be understood, the particular configuration shown is typical of a business organization network, although any other configurations, from single workstations directly connected to the Internet, to Internet service providers, to LANs, WANs, and intranets will work similarly. Components of the system that will be common to any configuration are one or more remote server(s) 10,11 that store data to be retrieved by one or more local workstations 40,42,44,46. The particular configuration of hardware used to implement the remote server(s) 10,11 is irrelevant, so long as the equipment is capable of communicating over a communications network such as the Internet 20. A web farm 30 is connected to the Internet and includes software and hardware for communicating over the Internet 20, and for downloading information from the Internet. Web farm 30 may include one or more linked servers 31,33,35. A plurality of workstations 40,42,44,46 are connected to web farm 30 via a local-area network (LAN), and/or a wide-area network (WAN) which may, but need not include Ethernet and/or Intranet-equipped hardware. Web farm 30 through is programmed to accept requests from individual workstations 40,42,44,46 forwarding these requests to the appropriate remote server(s) 10,11 over the Internet 20, and then receiving the requested data (e.g., web pages) and forwarding this data back to the requesting work station 40,42,44,46.

Pursuant to prior-art methods of data retrieval a user enters a request into a workstation 40 (such as by interacting with a web browser). The workstation application (browser) sends a request to web farm 30, which in turn sends the request to Internet 20, where the request is routed to a remote server 10. The remote server 10 returns the requested data through Internet 20 to web farm 30 and back to requesting workstation 40. Existing browsers store records including recently—downloaded data in a local cache 50, such as on the hard drive of a workstation 40. Similarly, workstation 42 is equipped with cache 52, workstation 44 is equipped with cache 54 and workstation 46 is equipped with cache 56. When a workstation operator makes a request, depending on the browser configuration, the workstation 40 may load the data directly from its local cache 50, or send a request to the remote server 10 to determine if any of the data have changed since the last download. This local cache 50 is only filled with data recently requested by a specific workstation 40, and does not include data requested only by other workstations 42,44 and 46.

The novel methods of the invention make use of a cache 43 of web farm 30. This cache 43 can be implemented on a data storage device associated with one or more of the servers 31,33,35 and accessible from any of the workstations 40,42,44,46. Note that each local cache 50,52,54,56 is only accessible from the respective workstation 40,42,44,46 associated with that corresponding local cache 50,52,54,56. Each of respective local caches 50,52,54,56 will store any pages recently accessed by a particular corresponding workstation 40,42,44,46 and retain them until a predetermined parameter, such as time elapsed since last access or overall allotted storage space, is exceeded.

An optional tracking mechanism may be implemented by one or more of the servers 31,33,35. This mechanism identifies one or more websites and/or remote servers which are accessed on a relatively frequent basis by any of the workstations. As a practical matter, information indicative of previously accessed websites and/or remote servers may be stored in a data storage mechanism associated with, and/or integrated into, any of servers 31,33,35. A processing mechanism at any of these servers 31,33,35 is then used to determine one or more websites or remote servers that are accessed on a more frequent basis than other websites or remote servers. This determination can be performed periodically, only once and/or on a prescheduled basis. Optionally and/or alternatively the server(s) 31,33,35 may allow a system administrator to specify in advance one or more websites or remote servers to which the automatic downloading and caching methods of the present invention are then applied. In any case, the website(s) and/or remote server(s) that are to be used for automatic downloading and caching are identified, by frequency-of use, and/or by operator specification. Next, the remote server(s) may implement a process whereby information from these identified website(s) and/or server(s) is automatically transferred to the web farm on a periodic and/or prescheduled and/or operator-initiated basis.

The system of the present invention includes functionality for caches at two levels—a first level comprising workstation caches 50,52,54,56, and a second level comprising web farm cache 43. Both levels, however, share some functions. The main differences between the two levels are the cache storage locations and subsequent accessibility. Within either level, the automatic caching methods of the present invention are initiated by an operator, and/or on a prescheduled basis, and/or at predetermined or periodic intervals. Once initiated, these automatic caching methods may continue running as a background process on one or more web farm servers 31,33,35 and/or be re-executed as needed or scheduled.

According to one preferred embodiment of the invention, HTTP (hyper-text transfer protocol) data transfer takes place between the web farm 30 and each of the workstations 40,42,44,46. By contrast, TCP/IP communications are employed between the web farm 30 and remote servers 10,11. In this manner, web farm 30 may be conceptualized as providing a first, relatively high-speed communications port connected to Internet 20 and adapted to communicate via HTTP protocols. Web farm 30 also provides a plurality of relatively low-speed communication ports adapted to communicate via TCP/IP protocols and adapted for coupling to any of a plurality of browser-equipped workstations. This configuration is advantageous in that relatively inexpensive hardware, such as coaxial cable and/or twisted pair, can be used to connect each of the workstations to the web farm. A higher-speed, more expensive link such as one or more T-1 lines, fiber optic cable, and/or another high-speed link can be used to connect the web farm to the Internet. Since it is expected that a number of workstations may be employed, whereas only a limited number of web farm to Internet connections will likely be used, significant cost savings will result over a system which uses T-1 lines for each of the workstations. Note that the second level provides a cache (web farm cache 43) that is accessible from any of the workstations 40, 42, 44, 46.

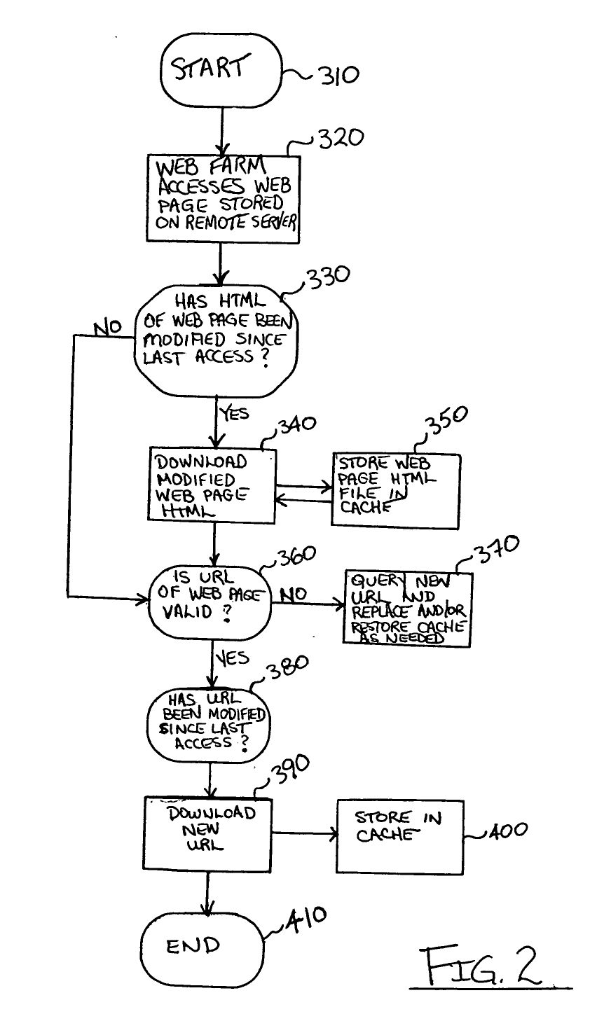

Referring now to FIG. 2, the logical flow of the automatic caching method is shown. At block 310, the method is commenced automatically on a prescheduled basis, and/or at a predetermined time and/or at periodic intervals, and/or commenced manually upon the request of an operator. Performance of the method can illustratively be illustratively initiated by issuing a Windows NT “AT” command. In some situations, it may be advantageous to schedule execution of the program during “off” hours, to reduce the load added by the method during peak usage hours. After the sequence of FIG. 2 is initiated, one or more web farm servers 31,33,35 scan the system registry of any workstations coupled to that server, so as to load all universal resource locators (URLs) under the HKEY_CURRENT_USER key under the parameter ExePage. These URLs are used as Internet Protocol (IP) addresses for downloading. If no addresses are found in the registry (discussed below), a set of default URLs set by the system administrator and included within the utility are used. The operational sequence of FIG. 2 then accesses each URL in turn (at block 320). The flowchart of FIG. 2 is then recursively executed for each URL. The web farm servers may, but need not, use the Microsoft Foundation Class C Internet session to negotiate the connections between the workstation(s) 40,42,44,46 (FIG. 1) and the remote servers 10,11.

As discussed below, each block of data, such as an HTML source file, is stored in one or more workstation caches 50, 52, 54, 56, and/or web farm cache 43, along with identifying information, such as the IP address, of the data block, and the date the data was last modified (variable C_last_mod). All of the embedded elements referenced with the HTML source file, such as pictures (JPGs, GIFs, etc.) or video (AVI, Quicktime, etc.) are also stored in the cache, and are stored with the IP address and the date last modified (variable E_last_mod). Upon accessing the remote server (block 320), web farm 30 queries the remote server 10 for the date the original was last modified (variable O_last_mod) (block 330). If O_last_mod is more recent than C_last_mod or if O_last_mod is more than a predetermined number of days away, the web farm 30 retrieves the modified HTML source file for the page (block 340) and stores it in the appropriate workstation cache (FIG. 1, 50,52,54,56) (block 350); and/or the modified HTML source file may also be stored at web farm cache 43. Optionally, the webfarm 30 can perform a test to ascertain which HTML Source files have been most frequently accessed, and then store those source files at web farm cache 43. The specific cache(s) where the source file is stored is discussed in greater immediately detail below, after the description of FIG. 2.

The system then scans through the HTML source files stored in the cache (old files as well as just-updated) and queries the address of each embedded element to determine if the URLs are still valid (i.e., may be accessed without error) (block 360). If the address has been moved or redirected, the new address is queried and the data are downloaded and stored in the appropriate cache, which is the workstation cached corresponding to the workstation that had requested the source file, and/or the web cache in the case of frequently accessed source files (block 370). The newer version of the source file replaces the older version if the address is valid and the remote server is queried for the last date the original element on the remote server was last modified (variableOE_last_mod) (block 380). If OE_last_mod is more recent than E-last_mod, or if OE_last_mod specifies a time no more than a predetermined number of days in the past, the data file is downloaded (block 390) and stored in the appropriate cache (block 400), replacing the older version. Logic blocks 320 through 400 are repeated until all of the embedded elements within the source file have been processed.

Preferably, the automatic caching methods of the present invention are executed multiple times during the day to ensure that the files stored in cache are relatively up to date. The methods are advantageously employed in the context of frequently updated data, such as incoming stock quotes and/or commodity prices. However, a vast number of web sites lend themselves easily to caching only a few times a day or less.

The techniques of the present invention can be applied, for example, to an operational environment where a group of financial consultants and/or stockbrokers are charged with the task of providing investment advice to clients. Each financial consultant and/or stockbroker may be provided with a corresponding workstation 40,42,44,46 (FIG. 1). One or more remote servers 10,11 are equipped with data specifying prices for each of a plurality of stocks. Throughout the business day, each of the workstations may need to access this information any number of times. However, the methods of the present invention can be utilized to automatically download this information on a periodic or prescheduled basis from remote server(s) 10,11 to web farm cache 43. The automatic downloading procedure is initiated by one or more processes performed by one or more of the web farm servers 31,33,35.

Once the files have been accessed and downloaded, the difference between the two levels of functionality of the automatic caching method becomes apparent. When running on a workstation 40 (FIG. 1), it is preferable for the workstation browser to be configured to retrieve requested data from its associated local cache 50, rather than connecting to the web farm 30 to retrieve it this data from web farm cache 43. If the file is not present in the cache 50, only then will it connect to the web farm 30 to retrieve the file from web farm cache 43. Thereafter, once % the above-described caching utility has sent the data to the local cache 50, the browser will appear to operate as usual.

The second level of functionality is organization-wide and occurs at the web farm 30 level. For those remote server sites and data that are likely to have organization-wide appeal, the following procedure may be followed. Rather than having each individual workstation 40 store the data in its local cache 50, which would create multiple, redundant copies throughout the organization, one copy of the data is stored in the web farm cache 43. The data are retrieved and updated in the web farm cache 43 just as with a local workstation cache 50. When a web farm server 31 receives a request from a workstation 40, the URL is compared with those associated with the data stored in the web farm cache 43. If the data for the requested URL is already stored in this cache, it is immediately returned to the workstation 40 without any request being sent to the Internet 20. The savings in data transfer time and web farm server load to the Internet are apparent.

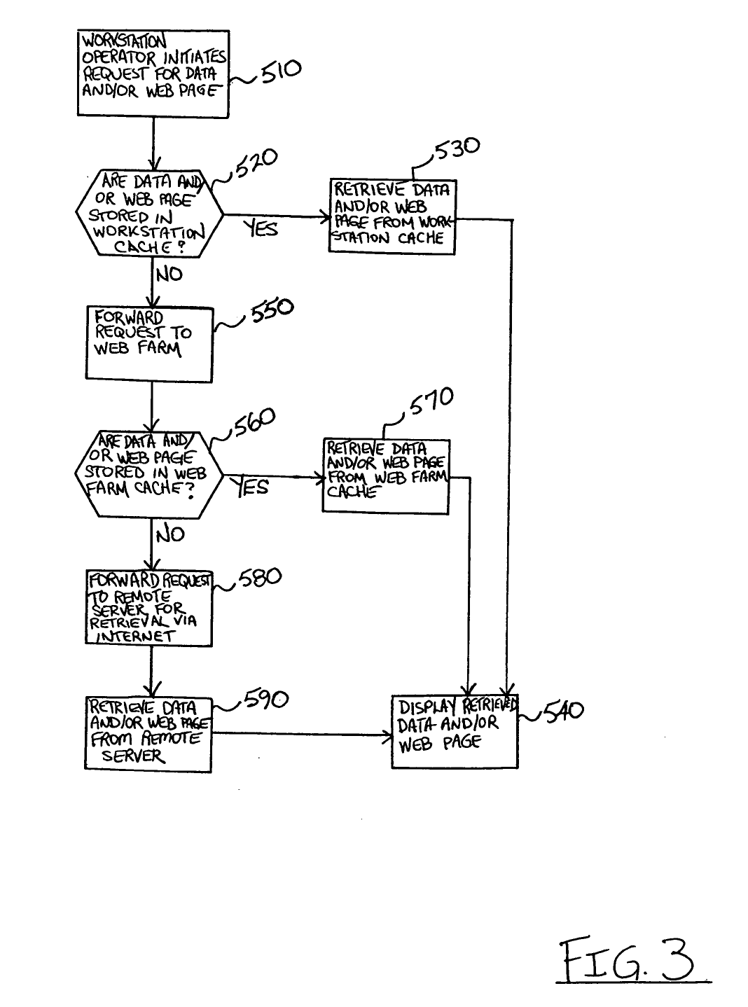

It is not necessary for both levels of functionality to be operational simultaneously. The aforementioned automatic caching methods may run solely on web farm 30. Assuming that both levels are operational, the operation of a workstation data retrieval request will proceed according to the logic shown in FIG. 3. At block 510, an operator initiates a data request through a local workstation 40 browser program. At block 520, the browser compares the URL of the request to those stored in the local workstation cache. If the data are contained in the cache, then the data are immediately retrieved (block 530) and displayed (block 540). If the data are not in the cache, the request is forwarded to the web farm (block 550). The web farm server compares the URL to those stored in the web farm cache 43 (FIG. 1) (block 560). If the data are contained in the web farm server cache, the database is immediately retrieved (block 570) and displayed (block 540). If the data are not in the web farm cache, the request is routed to a remote server 10 (FIG. 1) via the Internet (block 580). The data are then returned from the remote server (block 590) and displayed block 540).

The local workstation caches 50,52,54,56 (FIG. 1) and web farm cache 43 may be coordinated to eliminate duplication of data. This is accomplished at the web farm 30 server(s), which are programmed to block the storage of information in any of the local workstation caches if the information is already stored in the web farm cache 43. This results in overall storage savings throughout the organization.

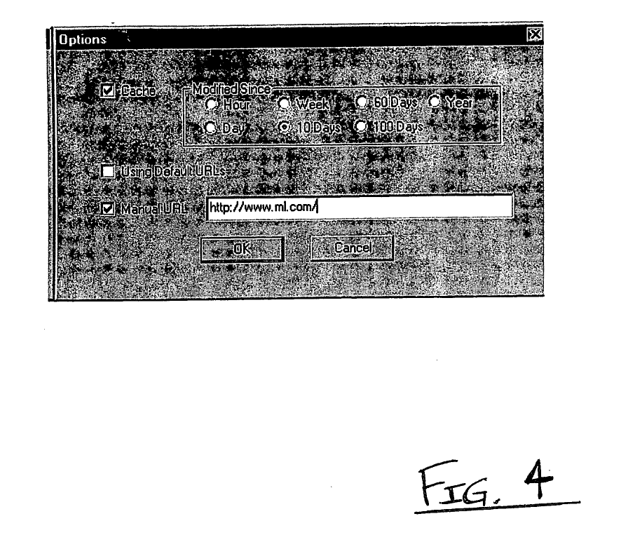

Referring now to FIG. 4, a screen that allows a user to input his/her selected sites for data caching is shown. As can be seen, the URL is entered in a dialog box. Through this screen, each user may customize the data that is cached on that user's workstation.

It can thus be seen that improved performance and increase efficiency is gained through the use of the caching utility shown and described in the above embodiments.

It is to be understood that the embodiments shown and described above are shown for the

1-75. (canceled)

76. A computer network system supporting multiple workstations having browser based communication software, said computer network system comprising:
a Web Farm, said Web Farm including plural communication ports to permit data transfer along communication links between one or more servers in said Web Farm and said plural browser based workstations, said communication links permitting data transfer of select Web-based data to said workstations in accordance with either HTTP or TCP/IP communication protocols;
at least one high speed communication link between said Web Farm and the Internet, wherein at least one server in said Web Farm includes a local cache for storing data received with said high speed communication link from one or more remote servers connected to the Internet;
said workstations further comprising a second local cache for storing data received from said workstation communication link to said Web Farm;
said system further comprising programming to control transfer of data between the Internet and the Web Farm, and further controlling data transfer between said Web Farm and each of said workstations in accordance with a selective algorithm to insure updating of frequently changing data on said remote servers and data frequently requested by said browser based workstations.

77. The system of claim 76 wherein said second local cache includes data stored in data blocks wherein said data block includes an originating IP address and time of last modification.

78. The system of claim 76 further comprising programming to ascertain a frequency of access of data stored at said Web Farm by said workstation.

79. The system of claim 78 further comprising programming for ascertaining a time period between last update times for data in said second cache and corresponding data in said Web Farm cache, and updating said data on said workstation cache when said period exceeds a select limit.

80. A system for distributing financial related data in support of brokerage and consulting functions, said system including:
plural, browser based workstations each providing a local workstation data cache to said browser for storing financial business related data, said data having time based marker to indicate an aging of said data;
a Web Farm comprising at least one local server for connecting to plural remote servers across the Internet, said Web Farm further comprising a Web Farm data cache, for storing financial data, said Web Farm further comprising programming for requesting and retrieving data from said remote servers in response to user requests entered at said workstations or automated requests generated in accordance with a frequency that said data is requested by said users.

81. The system of claim 80 or 76 further comprising programming to confirm accuracy and current availability of a URL associated with stored or requested data.

82. The system of claim 80 further comprising programming for storing in said Web Farm cache data having organizational value and associated use by plural workstations.

83. The system of claim 80 wherein said data comprises stock price information.

84. The system of claim 80 further comprising programming on said plural workstations to first query workstation cache for selected data and only if said selected data is not found in said workstation cache or has aged beyond a pre-sent limit, query said Web Farm cache for said selected data for transfer to said workstation cache.

85. The system of claim 76 further comprising programming on said Web Farm to poll connected workstations for URLs stored in a registry and to assign default URLs to one or more workstations missing a pre-set URL in its registry.

86. A data processing method for use in support of brokerage and/or financial consulting services including the steps of:
a. storing in a Web Farm, financial related data in a Web Farm cache;
b. entering commands in plural workstations, requesting financial related data for use by operators of said workstations;
c. retrieving, in response to said entered commands, said financial data corresponding to said commands from a workstation cache, if available;
d. retrieving, in response to said entered commands, said financial related data stored in said Web Farm corresponding to said commands, if available and not available in said workstation cache; and
e. retrieving, in response to said entered commands, said financial related data stored on one or more remote servers, if said financial related data is not available in either said workstation or Web Farm cache.

87. The method of claim 86 further comprising the steps of measuring frequency of requests for select data in said commands and automatically updating said select data that is frequently requested and storing said updates in said Web Farm cache.

88. The method of claim 87 wherein said data includes stock price and transaction information.

89. The method of claim 87 further comprising the step of removing data from said workstation cache that is redundant with data stored in said Web Farm cache.

90. The method of claim 87 further comprising the step of automatically updating data stored in said Web Farm cache with corresponding newer data from remote servers, if said Web Farm data ages beyond a pre-set limit.

91. The system of claim 80 further comprising programming on said Web Farm to poll connected workstations for URLs stored in a registry and to assign default URLs to one or more workstations missing a pre-set URL in its registry.
